(19) United States
(12) Patent Application Publication
(10) Pub. No.: US 2006/0051163 A1
(43) Pub. Date: Mar. 9, 2006

(54) Grid master

(76) Inventor: Gustav G. Hagberg, Lakewood, CO (US)

Correspondence Address: Gustav G. Hagberg, 1848 S. Quay St., Lakewood, CO, 80232, US

(21) Appl. No.: 10/831,093

(22) Filed: Aug. 31, 2004

(51) Int. Cl. F16L 1/00

(52) U.S. Cl. 405/180

(57) ABSTRACT

In the past, pipe pulling was limited to one blade, 12 inches to 18 inches long for pulling pipe for conventional irrigation systems. The Grid Master allows you to have several knives for pulling in grids of pipe for the new subsurface irrigation systems. The guide wheel assembly is what allows for speed of creating grids. Requiring no measuring or marking for the next line to be pulled in.

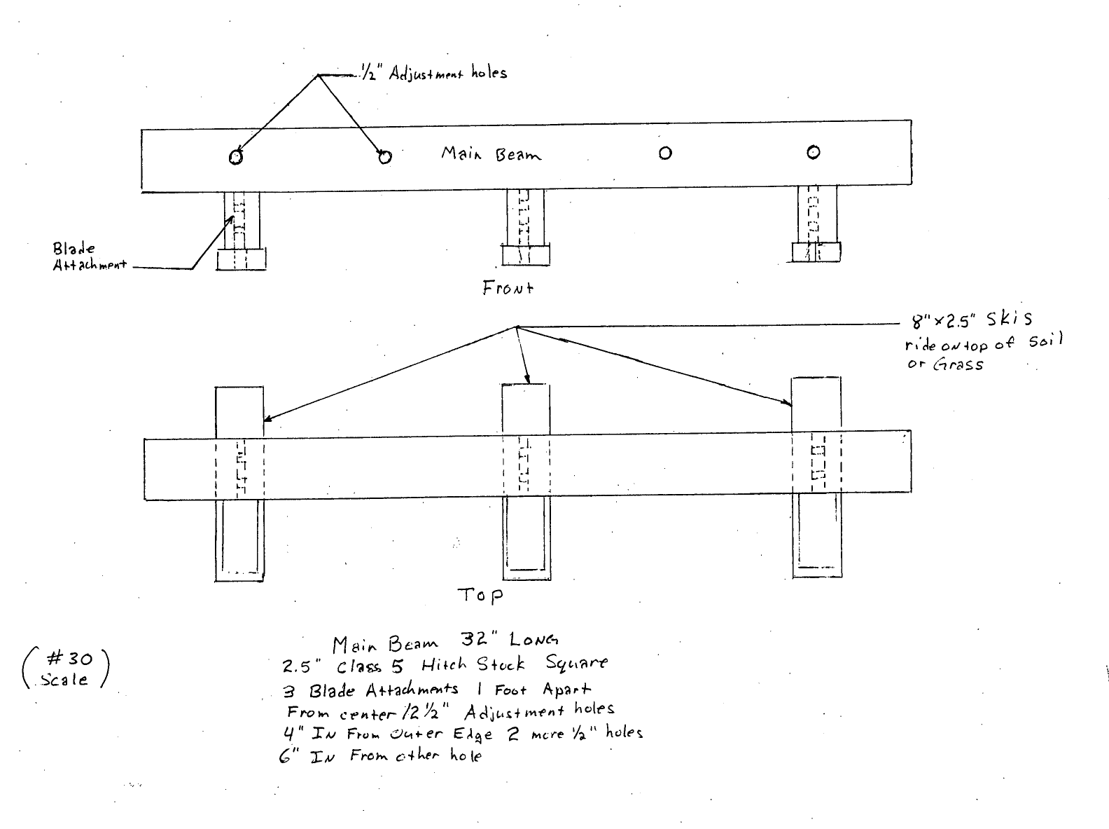

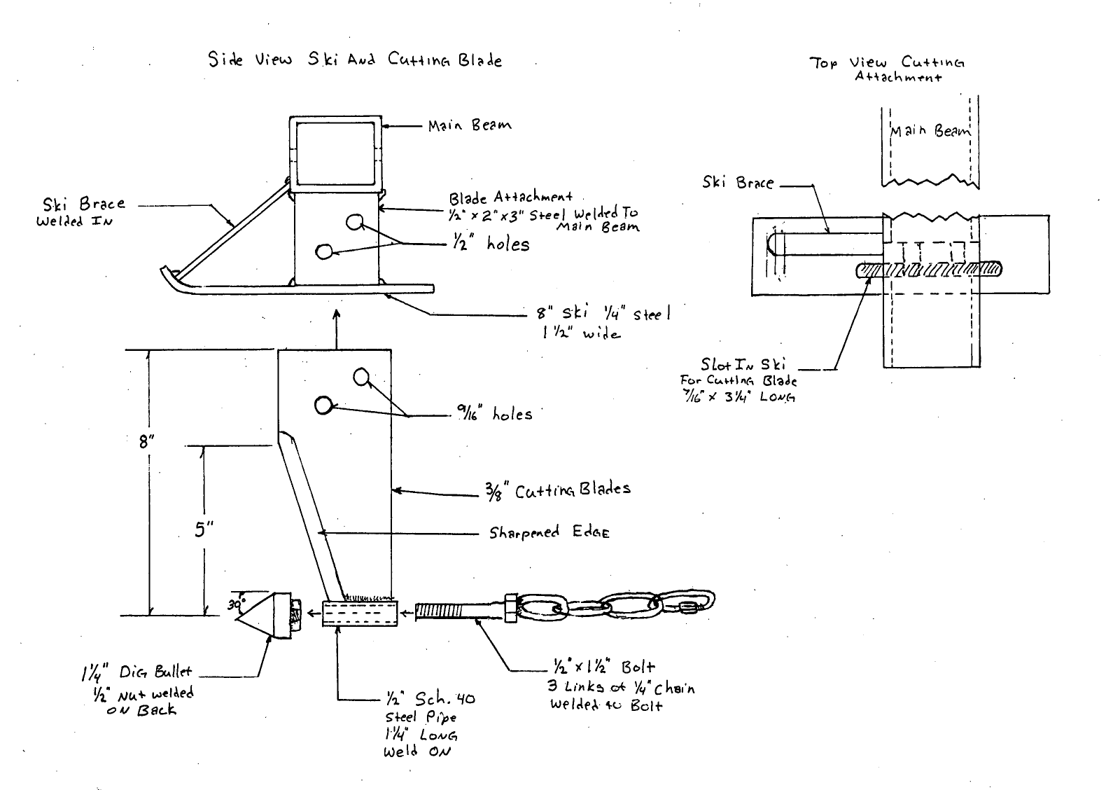

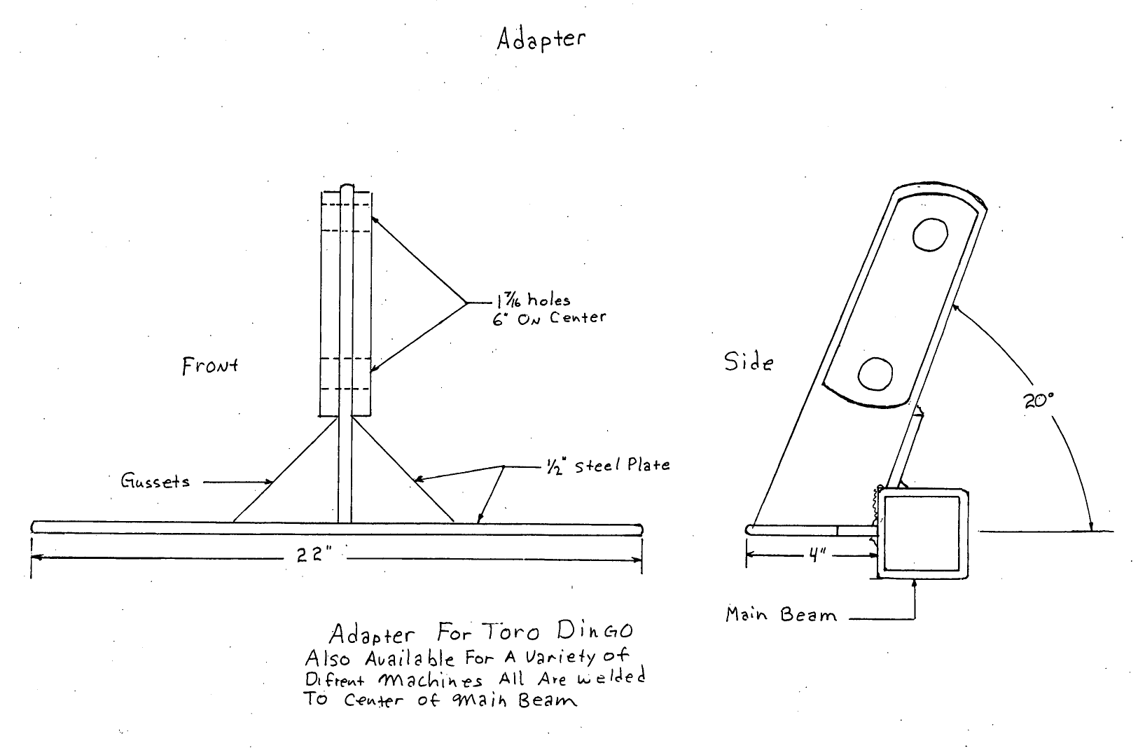

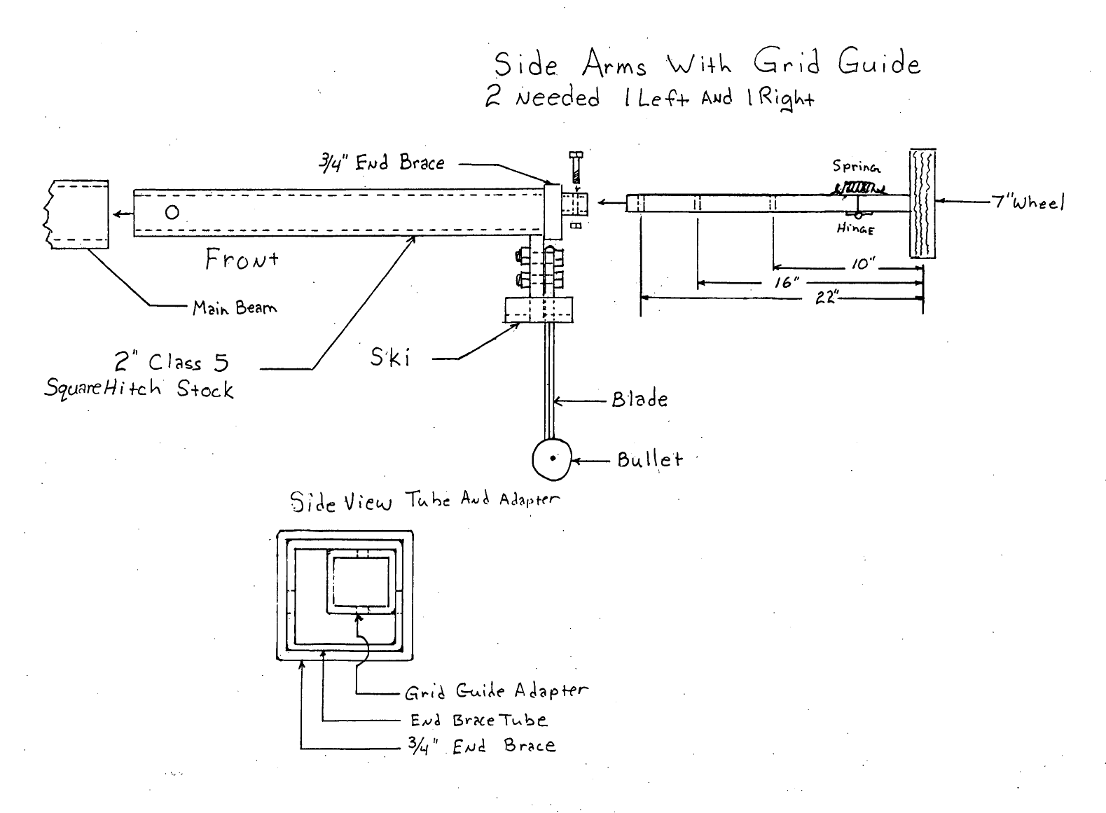

### CROSS REFERENCE

The Grid Master is largly based on a proven method of pulling pipe underground with the use of a cutting blade, with a bullet on the bottom front of the blade. Attached to the bullet is a chain or lost motion device with the pipe attachment on the other end of the lost motion device. A vibratory plow is used to pull the blade and pipe through the ground the Grid Master allows the operator to pull multiple lines at a specific depth at variable spacing incraments. It also allows the operator to pull off to one side of the machine. It is made to pull in grids of pipe.

### SPECIFICATION

The Grid Master is made of square tubing

Class 5 hitch tubing:
The main bar is 32″ long 2.5″ hitch tube.

It has 3 blade attachments and skis. Welded on the bottom of the tube at 1′ centers from the center of the tube. The blade attachments have 2½″ holes drilled at an angle to each other to attach the cutting blades with ½″×1½″ bolts grade 8. The adaptor is welded to the front of the main beam at an angle that allows the skis to be flush on the ground when the vibratory plow being used is in the down position. The side arms are made of 2″ tubing 14″ long, This allows the operator to have 5 cutting blades at 12″, 3 at 18″ or 3 at 24″ spacing. The main tube has 4½″ holes drilled through the tube 4″ and 10″ from each end. The side arms have a ½″ hohle drilled through it 2″ in on the opposite end of the blade. The side arms are attached to the main tube with 3½″×½″ bolts, grade 8. The second hole on the main tube 6″ in from the outside hole is what gives you the adjustment for variable spacing on the cutting blades. On the end of the side tubes an attachment tube of 1¼″ is welded inside with 1½″ extending past the blade end.

The grid measure wheeel is made of a 7″ steel wheel with rubber outer side. Welded to the end or a 1″×26″ peice of square tube with holes every 1″ is a wheel axle. The tube is cut in 2″ to 3″ from the end. A spring is attached to the bottom of the tube and a hinge to the top of the tube. This gives you the ability to go over uneven surfaces without bendinig the tube. The measuring wheel on the outside of the Grid Master Spaced at 1″, 18″ or 24″ allows the operator to pull a grid of pipes, switch direction, right or left and run the wheel down the outer mark from the previous pull. This saves time measuring, marking the next line and creates the prefect grid every time; perfect sapcing, perfect depth.

1. The Grid Master will save 40 to 80% of the labor cost of installating sub surface/underground irrigation systems using netafim piping or it's equivalent, which is designed to be installed at 1″, 18″ or 24″ spacing in all types of planting areas. This could be days or weeks depending on the project size.
